(19) United States
(12) Patent Application Publication
(10) Pub. No.: US 2026/0323509 A1
(43) Pub. Date: Oct. 15, 2026

(54) METHOD, APPARATUS, AND SYSTEM FOR CONTROLLING DISCONTINUOUS RECEPTION IN A WIRELESS DEVICE

(71) Applicant: Continental Automotive Technologies GmbH, Hannover (DE)

(72) Inventors: Rikin Shah, Langen (DE); David Gonzalez Gonzalez, Egelsbach (DE)

(73) Assignee: Continental Automotive Technologies GmbH, Hannover (DE)

(21) Appl. No.: 19/117,217

(22) PCT Filed: Sep. 25, 2023
(86) PCT No.: PCT/EP2023/076322

§ 371 Date: Mar. 31, 2025

(30) Foreign Application Priority Data
Sep. 30, 2022 (DE) 10 2022 210 400.5

(51) Int. Cl. H04W 52/02; H04W 76/28

(52) U.S. Cl. CPC H04W 52/0216; H04W 52/0235; H04W 76/28

(57) ABSTRACT

Wireless communication controls discontinuous reception in a user equipment connected to a wireless network node. A power saving signal is received from the network node during a first DRX cycle. The power saving signal includes at least a DRX update parameter. At least one second DRX cycle is adjusted based on the received update parameter. Aspects of the disclosure relates to an apparatus, a user equipment, and a wireless system for implementing such a method.

### CROSS-REFERENCE TO RELATED APPLICATIONS

The present application is a National Stage Application under 35 U.S.C. § 371 of International Patent Application No. PCT/EP2023/076322 filed on Sep. 25, 2023, and claims priority from German Patent Application No. 10 2022 210 400.5 filed on Sep. 30, 2022, in the German Patent and Trademark Office, the disclosures of which are herein incorporated by reference in their entireties.

### TECHNICAL FIELD

The present disclosure relates to discontinuous reception in wireless devices and more particularly to a method for optimizing power consumption when using multiple DRX configuration in a user equipment.

### BACKGROUND

In order to limit power consumption in LTE (Long Term Evolution), 5G or NR (New Radio) telecommunication systems, 3GPP (Third Partnership Project) introduced DRX (Discontinuous Reception) mode.

Because downlink data may arrive at any time, a user equipment (UE) needs to constantly monitor Physical Downlink Control Channel (PDCCH) in order to check if there is downlink data available. This consumes a lot of power.

DRX makes it possible for the UE to reduce power consumption by discontinuously receiving PDCCH: UE periodically enters a sleeping state for a certain period of time (OFF duration) during which PDCCH is not monitored before waking up for another period of time (ON duration) to monitor PDCCH for possible downlink data. DRX thus allows a reduction of power consumption.

UE and network need to be synchronized to avoid the network trying to send data while the UE is in sleeping state. To this end, the network configures UE with a set of DRX parameters, including “onDurationTimer” and “inactivity Timer” as defined in 3GPP specification TS 38.321. When a DRX period starts, UE stays active for a time period, referred as a “ON period”, which is configured through “onDurationTimer” parameter. If there is no PDCCH received during this time, the UE would enter DRX sleep state until the next active period. Whenever some activity occurs on PDCCH during the activity period, UE remains active and keeps monitoring for PDCCH for a duration configured through “inactivity Timer” parameter.

In some applications, like XR (augmented Reality), different traffic flows may be established between UE and a serving base station, including video, audio and pose flows, either in uplink or downlink directions. A base station may configure different overlaid DRX configurations to support such distinct traffic flows.

Unfortunately, multiple DRX configurations would increase UE's active time and, as a result, power consumption would also increase.

There is therefore a need for a method that would allow to reduce UE's active time when multiple DRX configuration are configured by a base station.

### BRIEF SUMMARY

In accordance with an aspect of the disclosure, there is provided a method of wireless communication for controlling discontinuous reception by a user equipment connected to a wireless network node, the method comprising:
Receiving a power saving signal from said network node during a first DRX cycle, said power saving signal comprising at least a DRX update parameter,
Adjusting at least one second DRX cycle based on said received update parameter.

It is therefore possible for a base station to punctually adjust one or more DRX configurations configured in a user equipment without having to send a whole DRX reconfiguration. Hence, when no downlink data is pending for said UE, or whenever a data flow characteristics changes, a base station may instruct the user equipment to update its DRX configuration to optimize power consumption. It is to be noted that such a DRX configuration update does not target the DRX cycle during which the configuration is received, but rather a distinct DRX cycle.

According to an embodiment, said first DRX cycle belongs to a first DRX configuration, and said second DRX cycle belongs to a second DRX configuration.

Such an arrangement makes it possible to adjust a specific DRX configuration based on a signaling received during an active period of a distinct DRX configuration. This allows a better reactivity when reducing power consumption. For instance, without such arrangement, a base station would need to wait for an activation period of a specific DRX configuration to transmit a signal instructing a user equipment to skip the next activation cycle, what would not be power-efficient. Instead, the base station can use the first available DRX activation slot to instruct a user equipment to skip next DRX cycle on a specific DRX configuration. This particularly advantageous in data flows involving XR, wherein several distinct data flows may be transferred using different DRX configurations.

In accordance with an embodiment, said DRX update parameter comprises at least an identifier of said second DRX configuration.

Hence, the power saving signal includes an identifier of one or more DRX configurations that should be adjusted using said discontinuous reception configuration update.

According to an embodiment, said DRX update parameter comprises at least an instruction for skipping said at least one second DRX cycle.

A base station may therefore instruct a user equipment to skip one or more DRX cycles. For example, when a base station knows that there is no pending downlink data, it can instruct a user equipment not to wake up during one or more upcoming DRX cycles. This allows a power consumption reduction because user equipment will not wake up if there is no downlink data to receive.

According to an embodiment, said DRX update parameter comprises at least a number of DRX cycles to be skipped.

It is thus contemplated that the skipping instruction included in the power saving signal is associated with a number of consecutive DRX cycles that should be skipped. User equipment may then adjust DRX cycles by skipping a specific number of DRX cycles as instructed by the base station.

According to an embodiment, said DRX update parameter comprises at least an instruction for shifting said at least one second DRX cycle.

Instead of skipping one or more specific cycles, or in addition, it is contemplated that DRX cycles from a specific DRX configuration may be time-shifted. For example, the power saving signal may comprise a shift instruction allowing a user equipment to delay or advance the next DRX cycle and upcoming ones. User equipment may then adjust DRX cycles by shifting specific DRX cycles according to the received instructions.

According to an embodiment said DRX update parameter comprises at least a time offset for shifting said at least one DRX cycle.

Such an arrangement allows a base station to fine-tune user equipment DRX cycles to match downlink data arrival rate. User equipment may thus adjust DRX cycles by shifting specific DRX cycles according to the time offset received in the DRX update parameter.

In accordance with an embodiment said power saving signal is carried over MAC CE and/or PDCCH.

Another aspect of the disclosure relates to an apparatus for controlling discontinuous reception in a wireless device connected to a wireless network node, said apparatus comprising a processor coupled to a memory in which computer program instructions are stored, said processor being configured by said instructions to perform the following acts:
Receiving a power saving signal from said network node during a first DRX cycle, said power saving signal comprising at least a DRX update parameter,
Adjusting at least one second DRX cycle based on said received update parameter.

According to an embodiment, the apparatus for controlling discontinuous reception is included in a user equipment device.

An aspect of the disclosure further relates to a wireless system comprising such a user equipment.

According to an embodiment, steps of the method described hereinabove are determined by computer program instructions.

Consequently, an embodiment of the present disclosure relates to a computer program stored on an information medium, said program being suitable to be implemented in user equipment device or more generally in a computer, said program comprising instructions configured to implement steps of the methods for controlling discontinuous reception in a wireless device which has just been described.

The program can use any programming language, and be in the form of source code, object code, or of code intermediate between source code and object code, such as in a partially compiled form, or in any other desirable form.

A further aspect contemplates a computer-readable information medium comprising computer program instructions for implementing steps of the method mentioned hereinabove.

The information medium may be any entity or device capable of storing the program. For example, the medium can comprise a storage means, such as a ROM, for example a CD ROM or a microelectronic circuit ROM, FLASH memory or any magnetic recording means, for example a hard drive.

Moreover, the information medium may be a transmissible medium such as an electrical or optical signal, which may be conveyed via an electrical or optical cable, by radio or by other means.

Alternatively, the information medium may be an integrated circuit into which the program is incorporated, the circuit being adapted to execute or to be used in the execution of the methods in question.

The advantages of the apparatus, user equipment, wireless system, computer program and information medium are identical to those presented in relation with the corresponding method according to any one of the embodiments mentioned hereinabove.

### BRIEF DESCRIPTION OF THE DRAWINGS

Other advantages and characteristics of the invention will be more clearly apparent on reading the following description, given by way of simple illustrative and nonlimiting example, and the appended drawings, among which:

FIG. 1 is a schematic diagram of a wireless communication system in which aspects of the method disclosed herein may be practiced, according to an embodiment,

FIG. 2 is a schematic diagram of a DRX cycle configuration on a user equipment,

FIG. 3 is a flow chart illustrating a method performed by a base station for configuring discontinuous reception in a user equipment, according to an embodiment of the present disclosure,

FIG. 4 is a flow chart illustrating a method performed by a user equipment for controlling discontinuous reception, according to an embodiment of the present disclosure,

FIG. 5 is a schematic diagram of a single DRX configuration configured on a user equipment,

FIG. 6 is a schematic diagram of multiple DRX configurations configured on user equipment according to an embodiment,

FIG. 7 is a schematic diagram of a single DRX configuration configured on user equipment according to an embodiment,

FIG. 8 shows an example of multiple DRX configurations configured on user equipment 101, according to an embodiment,

FIG. 9 is a block diagram showing an architecture of an apparatus suitable to implement a method for controlling discontinuous reception according to an embodiment,

FIG. 10 is a block diagram showing an architecture of an apparatus suitable to implement a method for configuring discontinuous reception according to an embodiment.

### DETAILED DESCRIPTION

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention.

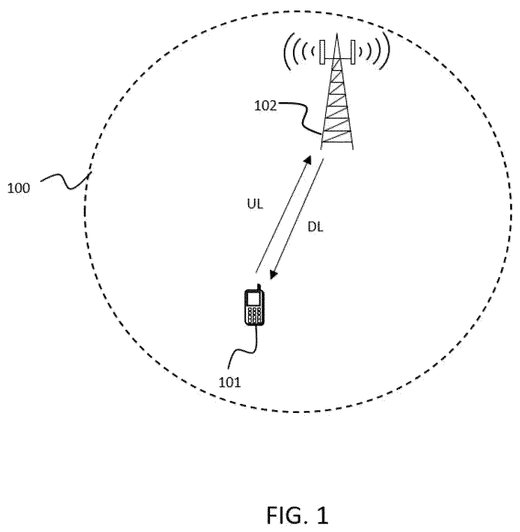

FIG. 1 shows an exemplary 5G New Radio (NR) wireless communication system 100 comprising a user equipment 101 and a base station 102 in which aspects of the present disclosure may be practiced. The wireless network 100 may be an LTE network or some other wireless network, such as 5G or NR network. The wireless network 100 may include one or more base stations 102. The base station 102 may be referred as BS, NB, eNodeB (or eNB), gNodeB (or gNB), an access point or the like, depending on the wireless standard implemented. Base station 102 provide radio communication coverage for a particular geographic area called “cell”. User equipment 101 may communicate with base station 102 through radio signals to access a core communication network. The base station 102 may communicate with user equipment 101 using downlink (DL) and uplink (UL) radio channels.

User equipment 101 may be referred as a mobile station, a wireless terminal, or the like. In some examples, user equipment 101 may be a cellular phone, a wireless modem, a wireless communication device, a handheld device, a laptop computer or the like. User equipment 101 may also be an IoT (internet of things) device, like wireless camera, a smart sensor or smart meter, a vehicle, a global positioning system device, or any other device configured to communicate through a wireless network.

In the following disclosure, reference will be made to user equipment 101 and base station 102 described above, with reference to FIG. 1.

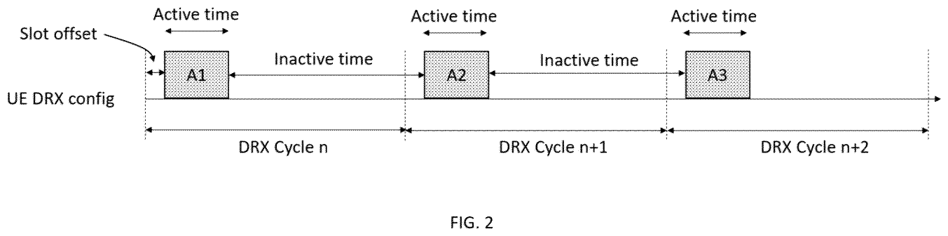

FIG. 2 is a schematic diagram of a DRX cycle configuration on a user equipment. Discontinuous reception (DRX) is a processing mode in a user equipment that aims at reducing power consumption. When using DRX, a user equipment periodically enters an active state to receive downlink data and signaling and then enters a sleep state to stop monitoring on downlink data.

FIG. 2 shows an exemplary DRX cycle configured in a user equipment, said cycle comprising an active time period (ON duration) and an inactive time period (OFF duration). The DRX cycle is periodically repeated, leading to several ON durations noted A1, A2 and A3 on FIG. 2.

DRX is configured by the base station using RRC (Radio Resource Control) signaling, e.g. RRC ConnectionReconfiguration or RRC Connection Setup. Among other, DRX parameters may include:
drx-onDuration Timer: the time during which user equipment should stay active after it wakes up (referenced as “Active Time” on FIG. 2). During this period, user equipment should monitor a physical downlink channel (e.g., PDCCH).
drx-inactivityTimer: this parameter corresponds to the delay during which the user equipment should remain in active state after being scheduled.
drx-SlotOffset defines the start of ON duration relative to the start of subframe boundary.

Once configured by the network, DRX cycles may be repeated until a new DRX configuration is received. Hence, user equipment may wake up even is there is no data to receive.

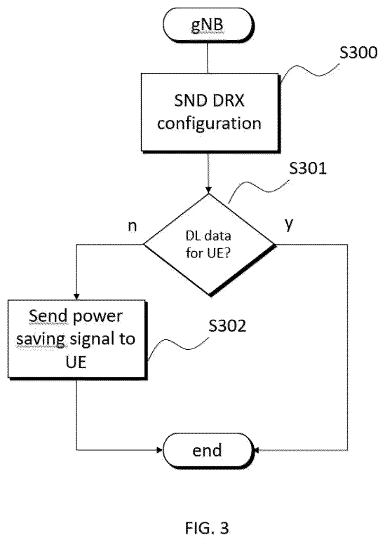

FIG. 3 is a flowchart showing main steps of a method performed by a base station, for configuring DRX in a user equipment.

During a first step S300, the base station 102 sends a DRX configuration to the user equipment 101 using a RRC connectionReconfiguration or RRC setup message. The DRX configuration comprises a set of DRX parameters suitable for the user equipment 101 to configure DRX cycle. According to an embodiment, the DRX configuration comprises multiple DRX configurations corresponding to distinct data flows.

The method further comprises a step S301 during which the base station 102 determines whether downlink data is available for transmission to the user equipment 101. As an example, the base station may determine whether data is available for user equipment 102 by checking a data buffer.

According to an embodiment, determining whether downlink data is available for transmission base station comprises predict whether downlink data will be available for transmission in the near future. Such a determination may be based on statistical approaches using spatial or temporal features, or by applying machine learning models to traffic data flows.

If the base station 102 determines at step S301 that no downlink data transmission will be required for a certain amount of time, either because no downlink data is pending so far or because no downlink data is expected for the user equipment 101, the base station 102 may send a power saving signal (PSS) to the user equipment during a step S302, said transmission of a PSS occurring during an activation period of the user equipment.

According to an embodiment, the power saving signal is carried over MAC CE and/or PDCCH.

In a possible embodiment, the power saving signal may comprise one or more instructions associated with one or more parameters, allowing user equipment 101 to adjust at least one DRX activation period that is distinct from the activation period during which PSS is received by user equipment.

According to an embodiment, said parameters may comprise one or more DRX configuration identifiers, indicating to which of multiple possible DRX configurations should be affected by PSS parameters.

According to an embodiment, said instructions may comprise a skip instruction for skipping one or more DRX activation periods. It is contemplated that the skip instruction may be associated in PSS with a parameter including a number of DRX cycle to skip after the current cycle has ended.

According to an embodiment, said instructions may comprise a shift instruction for shifting DRX cycles. It is contemplated that the shift instruction includes a positive or negative shifting offset parameter.

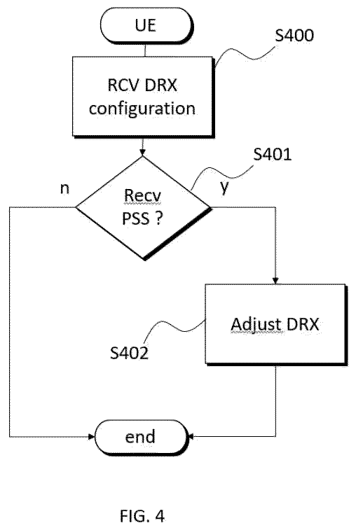

FIG. 4 is a flowchart showing main steps of a method performed by a user equipment for controlling DRX.

During a first step S400, user equipment 101 receives the DRX configuration sent by the base station 102 at step S300 and configures one or more DRX cycles. The received DRX configuration may be received in a RRC connectionReconfiguration or RRC setup message. The DRX configuration comprises a set of DRX parameters suitable for the user equipment 101 to configure DRX cycle. According to an embodiment, the DRX configuration comprises multiple DRX configurations corresponding to distinct data flows.

At step S401, the user equipment 101 may receive a Power Saving Signal (PSS) sent by the base station 102 during an active downlink monitoring period of a particular DRX configuration. According to an embodiment, the received PSS may be received over MAC CE and/or PDCCH.

In a possible embodiment, the received PSS may comprise one or more instructions associated with one or more parameters, allowing user equipment 101 to adjust at least one DRX activation period that is distinct from the activation period during which PSS is received by user equipment.

During step S402, user equipment 101 adjusts the DRX configuration according to instructions and parameters included in the received PSS.

According to an embodiment, said instructions received in PSS comprise at least a skip instruction for skipping one or more DRX upcoming activation periods. It is contemplated that the skip instruction may be associated in PSS with a parameter including a number of DRX cycle to skip after the current cycle has ended.

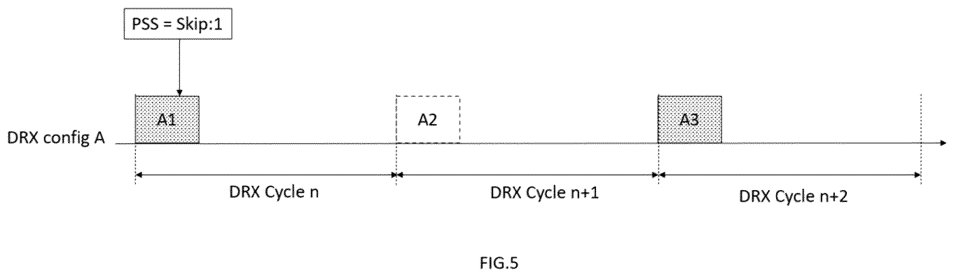

FIG. 5 is a schematic diagram of a single DRX configuration configured on user equipment 101 according to an embodiment. FIG. 5 shows a subset of 3 DRX cycles (n, n+1, n+2) within said DRX configuration and an exemplary Power Saving Signal received by user equipment 101 during an active period A1 (ON duration) of DRX cycle n. The received PSS comprises a “skip” instruction associated with a “1” parameter, indicating that UE should skip one DRX cycle after the current cycle. As shown by the dashed A2 period on FIG. 5, the ON duration A2 from the DRX cycle n+1 that follows the DRX cycle n during which the PSS was received is skipped accordingly, meaning that the user equipment will not switch to active state until DRX cycle n+2.

According to an embodiment, the received power saving signal PSS may comprise an identifier of a DRX configuration that shall be adjusted by instructions and parameters included in the PSS.

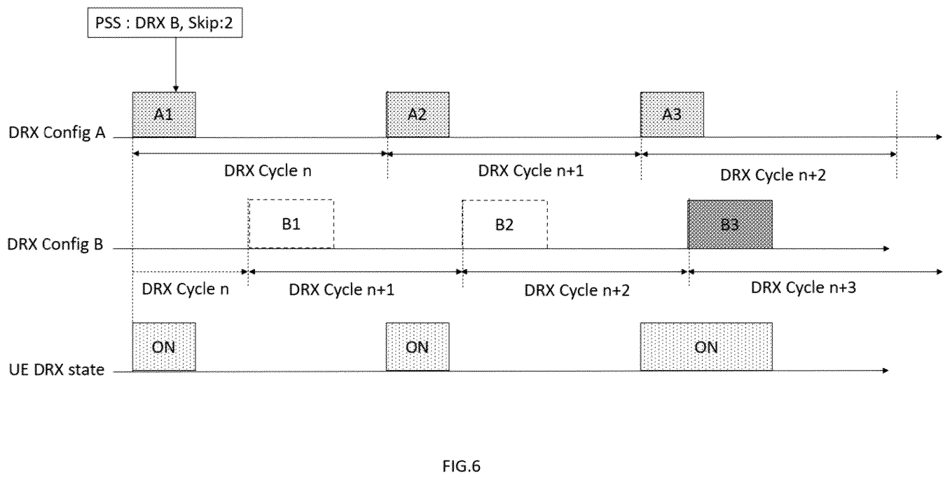

FIG. 6 is a schematic diagram of multiple DRX configurations configured on user equipment 101 according to an embodiment.

FIG. 6 shows a first DRX configuration “DRX config A” and a second DRX configuration “DRX config B”. The resulting activation state of the user equipment is shown under “UE DRX State”, which is an overlay of DRX Config A and DRX config B.

FIG. 6 further shows a Power Saving Signal received during an active period A1 of the DRX configuration A. The PSS includes an identifier of a DRX configuration B (DRX B), a “skip” instruction and a skip parameter value “2”, meaning that user equipment 101 shall not wake up for two next DRX cycle on configuration B. Hence, activation B1 and B2 are skipped on configuration B. As shown on the resulting UE activation state (UE DRX state), user equipment 101 still wakes up during DRX cycles from configuration A. After skipping DRX cycles n+1 and n+2, previous DRX behavior is restored, and UE enters an active state B2 during DRX cycle n+3.

According to an embodiment, said instructions received in PSS by user equipment 101 comprises at least a shift instruction for shifting DRX cycles. It is contemplated that the shift instruction includes a positive or negative shifting offset parameter.

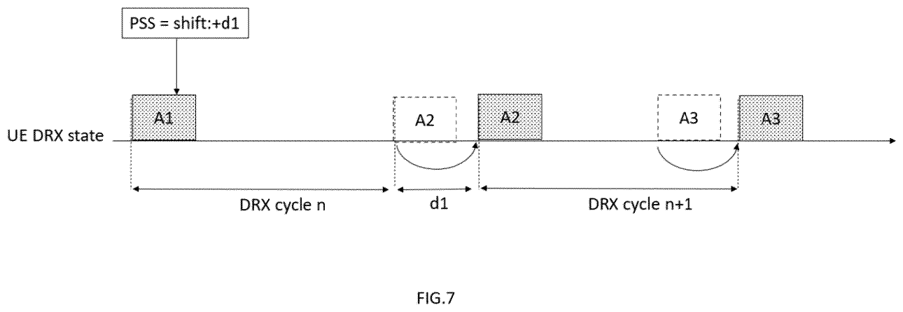

FIG. 7 is a schematic diagram of a single DRX configuration configured on user equipment 101 according to an embodiment. FIG. 7 shows a Power Saving Signal received by user equipment 101 during an active period A1 of a DRX cycle n. The received PSS includes a “shift” instruction and a shifting offset “+d1”. Upon receiving such PSS, user equipment 101 shifts the starting of the next DRX cycle (DRX cycle n+1) based on the provided offset. Hence, activation periods A2, A3 and other upcoming activation periods associated with the current DRX configuration are also shifted. The present disclosure also contemplates that the provided offset could be a negative offset.

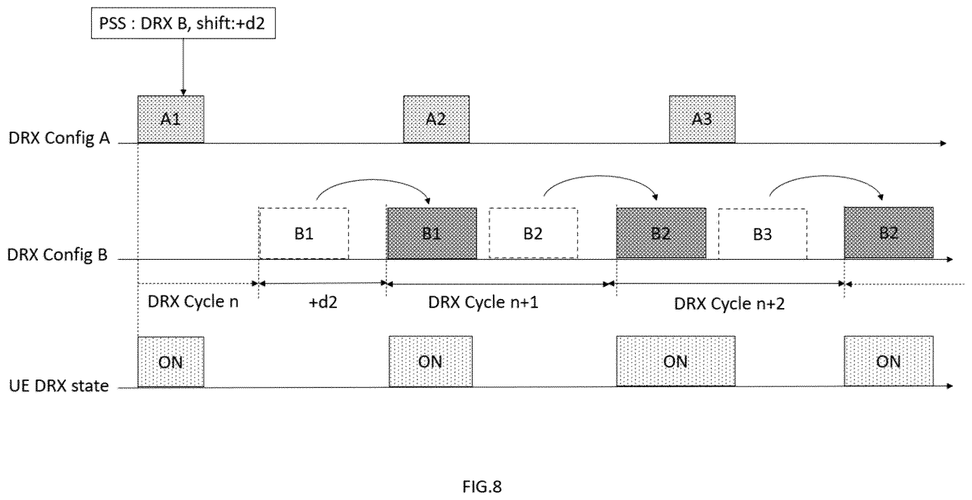

FIG. 8 shows an example of multiple DRX configurations configured on user equipment 101, according to an embodiment, wherein a PSS is received during an active period A1 of a first DRX configuration (DRX Config A). The received PSS comprises a “shift” instruction along with an offset d2 to be applied to the upcoming DRX cycles of DRX configuration B2. As shown on FIG. 8, upon reception of such PSS, user equipment 101 shifts the starting of DRX cycle n+1 based on the received offset “+d2”. In other words, a delay of duration d2 is inserted between the end of DRX cycle n and the beginning of DRX cycle n+1. Hence, all upcoming DRX cycle that belongs to DRX config B are shifted as well.

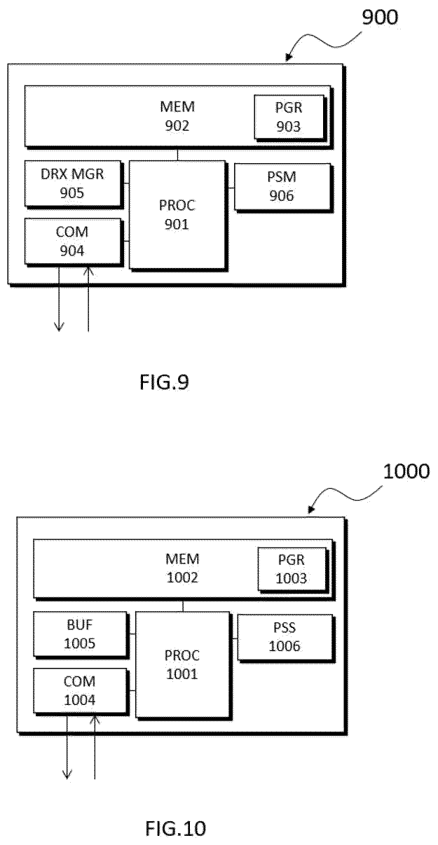

FIG. 9 shows a schematic architecture of an apparatus 900 suitable to implement a method of wireless communication for controlling discontinuous reception, according to an embodiment.

The apparatus 900 comprises a processor 901 and a memory 902, for example a Random Access Memory (RAM). The processor 901 may be controlled by a computer program 903 stored in the memory 902 comprising instructions configured to implement a method of wireless communication for controlling discontinuous reception according to an embodiment.

More precisely, the computer program 903 comprises instructions configured to implement steps of receiving a power saving signal from said network node during a first DRX cycle, said power saving signal comprising at least a DRX update parameter, and adjusting at least one second DRX cycle based on said received update parameter.

On initialization, the computer program instructions 903 may be loaded into the memory 902 before being executed by the processor 901. The processor 901 implements the steps of the method according to the instructions of the computer program 903.

The apparatus 900 comprises a wireless communication unit 904 configured to exchange data using radio signals. The communication unit 904 may be a 3G, 4G, 5G, NR, WiFi or Wimax transceiver suitable for establishing connections and exchange data with a base station of a wireless network. The communication unit may be configured to receive at least one DRX configuration sent by a base station and to monitor a downlink channel to receive data from said base station.

The apparatus 900 further comprises a DRX manager module 905 configured to apply at least one DRX configuration received from a base station through the communication unit 904. The DRX manager module may be implemented by computer program instructions configured to periodically activate and deactivate a receiver unit of the communication module 904 according to parameters received in said DRX configuration.

The apparatus 900 further comprise a power saving module 906. The power saving module 906 may be configured by computer program instructions to obtain at least a DRX update parameter from a power saving signal sent by a base station over PDCCH or MAC CE and received by the communication unit 904 during a first DRX cycle. The power saving module 906 may be further configured to command the DRX manager module 905 in order to adjust at least one second DRX cycle based on said received update parameter. According to an embodiment, the power saving module may send a skip instruction to the DRX manager module 905, along with a number or DRX cycle to skip and/or one or more DRX configuration identifiers, the DRX manager module being further configured by computer program instructions to update the activation timing of the receiver of the communication unit 904 in order to skip one or more DRX cycle.

According to an embodiment, the power saving module 906 may send a shift instruction to the DRX manager module 905, along with a time offset and/or one or more DRX configuration identifiers, the DRX manager module 905 being further configured by computer program instructions to update the activation timing of the receiver of the communication unit 904 in order to shift one or more DRX cycle based on the supplied time offset value.

According to an embodiment, the apparatus 900 is included in a user equipment device.

FIG. 10 shows a schematic architecture of an apparatus 1000 suitable to implement a method of wireless communication for configuring discontinuous reception in a user equipment device, according to an embodiment.

The apparatus 1000 comprises a processor 1001 and a memory 1002, for example a Random Access Memory (RAM). The processor 1001 may be controlled by a computer program 1003 stored in the memory 1002 comprising instructions configured to implement a method of wireless communication for configuring discontinuous reception according to an embodiment.

More precisely, the computer program 1003 comprises instructions configured to implement steps of determining whether downlink data is available for transmission to a user equipment and transmitting a power saving signal to said user equipment if no downlink data is determined available, said power saving signal comprising at least one instruction for adjusting at least one DRX configuration of said user equipment.

On initialization, the computer program instructions 1003 may be loaded into the memory 1002 before being executed by the processor 1001. The processor 1001 implements the steps of the method according to the instructions of the computer program 1003.

The apparatus 1000 comprises a wireless communication unit 1004 configured to exchange data using radio signals. The communication unit 904 may be a 3G, 4G, 5G, NR, WiFi or Wimax transceiver suitable for establishing connections and exchange data with one or more user equipment of a wireless network. The communication unit 1004 may be configured to send at least one DRX configuration to a user equipment using RRC and to schedule data DL transmission to said user equipment according to said DRX configuration transmitted to said user equipment.

According to a possible embodiment, the apparatus 1000 may further comprise a buffer 1005 for buffering incoming data pending for transmission to a user equipment. The buffer 1005 may comprise queue implemented in a memory, for example a RAM, suitable for temporarily storing incoming messages before sending to a user equipment.

The apparatus 1000 may further comprise a power saving module 1006. The power saving module may be configured by computer program instructions to determine whether downlink data is waiting for transmission in the buffer 1005 and to transmit a power saving signal to a user equipment through the communication module 1004 when it is determined that no downlink data is pending for said user equipment, said power saving signal comprising at least a DRX update parameter. According to an embodiment, said DRX update parameter may comprise a skip instruction for indicating the user equipment to skip at least one DRX cycle, and/or a number of DRX to be skipped, and/or a DRX configuration identifier of a DRX configuration in which a DRX cycle should be skipped.

According to an embodiment, the power saving module 1006 may determine a time offset between data arrival rate in the buffer 1005 and the current DRX configuration configured in a user equipment to which said data should be transmitted. In other word, the power saving module may detect that there is a mismatch between the timing of the incoming data and the current DRX configuration timing of the destination user equipment. In such case, the power saving module may transmit a power saving signal to a user equipment through the communication module 1004, said power saving signal comprising at least a shift instruction and a time offset determined to align the wakeup time of the user equipment with the data arrival time.

According to an embodiment, the apparatus 1000 is included in a wireless network node, for example a base station device.

The present disclosure also contemplates a system of wireless communication for controlling discontinuous reception, said system comprising a user equipment implementing the above-described method for controlling DRX and a base station implementing the above-described method for configuring DRX.

1. A method of wireless communication for controlling discontinuous reception in a user equipment connected to a wireless network node, the method comprising:
Receiving (S401) a power saving signal from said network node during a first DRX cycle, said power saving signal comprising at least a DRX update parameter,
Adjusting (S402) at least one second DRX cycle based on said received update parameter.

2. A method according to claim 1 wherein said first DRX cycle belongs to a first DRX configuration and said second DRX cycle belongs to a second DRX configuration.

3. A method according to claim 2 wherein said DRX update parameter comprises at least an identifier of said second DRX configuration.

4. A method according to claim 1 wherein said DRX update parameter comprises at least an instruction for skipping said at least one second DRX cycle.

5. A method according to claim 4 wherein said DRX update parameter comprises at least a number of DRX cycles to be skipped.

6. A method according to claim 1 wherein said DRX update parameter comprises at least an instruction for shifting said at least one second DRX cycle.

7. A method according to claim 6 wherein said DRX update parameter comprises at least a time offset for shifting said at least one DRX cycle.

8. A method according to claim 1 wherein said power saving signal is carried over MAC CE and/or PDCCH.

9. An apparatus for controlling discontinuous reception in a wireless device connected to a wireless network node, said apparatus comprising a processor (901) coupled to a memory

(902) in which computer program instructions (903) are stored, said processor being configured by said instructions to perform the following acts:
Receiving, using a communication unit (904) a power saving signal from said network node during a first DRX cycle, said power saving signal comprising at least a DRX update parameter,
Adjusting at least one second DRX cycle based on said received update parameter.

10. A user equipment device comprising an apparatus according to claim 9.

11. A wireless communication system comprising a user equipment according to claim 10.
